(19) United States
(12) Patent Application Publication
(10) Pub. No.: US 2006/0009593 A1
(43) Pub. Date: Jan. 12, 2006

(54) Polyaddition compound and cationic electrodeposition paint which contains polyaddition compound

(76) Inventors: Hideki Iijima, Tsukui-gun (JP); Koji Kamikado, Yokohama-shi (JP); Masaharu Shimoda, Hiratsuka-shi (JP); Akihiko Shimasaki, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/176,216

(22) Filed: Jul. 8, 2005

(30) Foreign Application Priority Data
Jul. 8, 2004 (JP) 2004-202285

(51) Int. Cl. C08G 59/50; C08L 63/00

(52) U.S. Cl. 525/523

(57) ABSTRACT

This invention provides a polyaddition compound of a glycidyl ether compound (a₁) having a polyoxyalkylene chain with an amine compound (a₂) having at least one active hydrogen, which has a weight average molecular weight of 250-10,000, said polyaddition compound, when used for cationic electrodeposition paint, giving a coating film which is excellent in coating workability such as appearance, oil-cissing resistance and water mark insensibility, and in sealer adhesion, corrosion resistance and paint stability, having good paint stability, and being capable of both incorporation into emulsion and post-addition to paint.

### BACKGROUND OF THE INVENTION

1. Field of the Invention

This invention relates to a novel polyaddition compound which has polyoxyalkylene chain, and also to cationic electrodeposition paint containing said polyaddition compound which is capable of forming a coating film excellent in coating workability such as appearance, oil-cissing resistance and water mark insensibility, and also in adhesion to topcoat coating film.

2. Description of the Prior Art

Cationic electrodeposition paint is used for various purposes such as automobile body and automobile parts, and, therefore, there have been developed a variety of products with different special properties.

Properties which cationic electrodeposition paint is required to have include coating workability such as appearance, oil-cissing resistance, water mark insensibility and contamination resistance, and adhesion to topcoat coating film. These properties are important items when automobile body of a complicated shape is to be coated on a line.

In order to improve the above-mentioned properties, there has been employed a method of adding surface treating agent or the like to cationic electrodeposition paint. Examples of such a method include Method (1) and Method (2) as follows: Method (1): Surface treating agent is incorporated into paint to make emulsion. For instance, surface treating agent is dispersed into an aqueous medium together with a base resin such as amino group-containing epoxy resin, a curing agent such as blocked polyisocyanate and with other additive to make emulsion. Then, with use of said emulsion and a pigment-dispersed paste, cationic electrodeposition paint is produced.

Method (2): A bath of cationic electrodeposition paint is produced beforehand with use of emulsion and pigment-dispersed paste, and, thereafter, surface treating agent is added to the bath.

In Method (1), surface treating agent is emulsified together with a base resin and a curing agent, and, therefore, the dispersibility of emulsion lowers, and the particle size of emulsion increases, with the result that paint stability may be damaged, and that appearance and corrosion resistance may decrease.

In Method (2), on the other hand, surface treating agent may be inharmonious with the bath of cationic electrodeposition paint or with the formed coating film, with the result that there may occur apparatus trouble such as the clogging of Filtration equipment or Ultra Filtration equipment, the dropping of sealer, and the peeling and/or cissing of intermediate and/or topcoat coating film.

In order to solve these problems, Japanese Patent Publication No. Hei 6 (1994)-76568, for example, proposed to blend, in cationic electrodeposition paint, cationically electrodepositable gelatinized fine particles which are prepared by dispersing in water a hydrolysable alkoxysilane group-containing amine adduct of epoxy resin, so that the surface adjusting effect of the cationically electrodepositable gelatinized fine particles may give cissing-preventing effect to the formed coating film. Said cationically electrodepositable gelatinized fine particles have, however, a problem; although they show cissing-preventing effect when post-added to cationic electrodeposition paint (i.e., applicable to Method (2) above), there may be caused damage in the appearance of coated surface or the decrease of paint stability when thus prepared cationic electrodeposition paint is subjected to a long period of continuous mechanical shear given by pump circulation or stirring.

Japanese Patent Application KOKAI Publication No. 2001-3005 discloses cationic electrodeposition paint which contains, as a surface treating agent, polyether polyol like alkylene polyether polyol such as polymethylene glycol, polyethylene glycol, polypropylene glycol and polybutylene glycol, or aromatic ring-containing polyether polyol which is prepared from a reaction of bisphenol or from a reaction between bisphenol and glycol, and which shows no decrease in appearance and corrosion resistance. The surface treating agent which is disclosed in Japanese Patent Application KOKAI Publication No. 2001-3005 has no water-dispersibility and is unable to be post-added to a bath of cationic electrodeposition paint; this surface treating agent is therefore incapable of microadjustment to improve the cissing-preventing effect of coating film. Furthermore, when this surface treating agent is added in a large amount, there may occur decrease of adhesion between thus formed electrocoating film and sealer, or between the electrocoating film and intermediate and/or topcoat coating film.

Japanese Patent Application KOKAI Publication No. 2001-288407 proposes to inhibit the occurrence of oil cissing, dry mark and water mark insensibility on a coating film by adding, to cationic electrodeposition paint, a hydrophobic acrylic resin and an adduct of higher alcohol with ethylene oxide and/or propylene oxide which adduct has a specific molecular weight distribution and a specific HLB. In the method as disclosed in this Japanese Patent Application KOKAI Publication No. 2001-288407, however, it is essential to add two components for emulsion, i.e., a hydrophobic acrylic resin and an adduct of higher alcohol with ethylene oxide and/or propylene oxide which has a specific molecular weight distribution and a specific HLB. Furthermore, depending on the blending proportion of these two components, oil cissing or dry mark may still occur to decrease coating workability.

Japanese Patent Application KOKAI Publication No. 2002-294165 proposes an idea to include, in electrodeposition paint, an aminoether-modified epoxy resin having a polyether chain with a number average molecular weight of 20,000-100,000 which is obtained from a reaction between diepoxy compound and aminopolyether, as a surface treating agent.

Said surface treating agent is capable of post-addition to electrodeposition paint as in the above-mentioned Method (2), and shows good stability under a condition of mild stirring of paint (e.g., in a laboratory can or a small scale tank). When, however, the paint is subjected to a long period of shear by Filtration equipment or Ultra Filtration equipment on a coating line, a part of surface treating agent may agglomerate to cause trouble such as the clogging of Filtration equipment or Ultra Filtration equipment, or the adhesion of seeding bittness on the surface of coating.

### SUMMARY OF THE INVENTION

The objective of this invention is to provide a surface treating agent for cationic electrodeposition paint which surface treating agent is applicable to both addition methods, i.e., Method (1) and Method (2) as mentioned above, and which is well-balanced in coating workability such as appearance, oil-cissing resistance, water mark insensibility and contamination resistance, adhesion to topcoat coating film, paint stability on a coating line, curability and corrosion resistance.

The inventors of this invention have made assiduous study with a view to achieving the above-mentioned objective, and, as a result, have found out that a polyaddition compound having a weight average molecular weight of 250-10,000 which is produced from a reaction between a glycidyl ether compound having a polyoxyalkylene chain and an amine compound having active hydrogen is applicable to both addition methods, i.e., a method wherein a surface treating agent is incorporated in paint to make emulsion and a method wherein there is prepared a bath of cationic electrodeposition paint to which a surface treating agent is subsequently added, and that cationic electrodeposition paint which contains said surface treating agent gives a coating film which is excellent in coating workability such as appearance, oil-cissing resistance, water mark insensibility and contamination resistance, adhesion to topcoat coating film, paint stability on a coating line, curability and corrosion resistance, and have so completed this invention.

Thus, this invention provides a polyaddition compound (A) of a glycidyl ether compound (a₁) having a polyoxyalkylene chain with an amine compound (a₂) having at least one active hydrogen, which has a weight average molecular weight of 250-10,000.

This invention also provides a cationic electrodeposition paint which comprises, as a base resin, amino group-containing epoxy resin produced from an addition reaction between epoxy resin and amino group-containing compound, and, as a curing agent, a blocked polyisocyanate compound, and, blended or added thereto, also the above-mentioned polyaddition compound (A) in the proportion of 0.1-20 parts by weight per 100 parts by weight of total solid content of base resin and curing agent.

The polyaddition compound of this invention is applicable to both addition methods, i.e., a method wherein the polyaddition compound is incorporated, as a surface treating agent, in paint to make emulsion, and a method wherein there is prepared a bath of cationic electrodeposition paint to which the polyaddition compound is thereafter added as a surface treating agent. Moreover, cationic electrodeposition paint which contains the polyaddition compound of this invention gives a coating film which is excellent in coating workability such as appearance, oil-cissing resistance, water mark insensibility and contamination resistance, adhesion to topcoat coating film, paint stability on a coating line, curability and corrosion resistance.

The following is a more detailed explanation of the polyaddition compound and the cationic electrodeposition paint of this invention.

### DETAILED DESCRIPTION OF THE INVENTION

Polyaddition Compound (A):

Polyaddition compound (A) is produced from a reaction between a glycidyl ether compound (a₁) having a polyoxyalkylene chain and an amine compound (a₂) having at least one active hydrogen, and has a weight average molecular weight of 250-10,000.

Glycidyl ether compound (a₁) having a polyoxyalkylene chain includes compounds which have, in a molecule, at least one glycidyl group and a polyoxyalkylene chain (this polyoxyalkylene chain may be composed of one species of oxyalkylene units, or two or more species of oxyalkylene units). Concrete examples of (a₁) are compounds of formulae (1), (2) and (3) as follows. 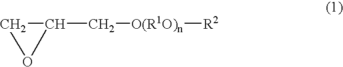
wherein R¹'s in recurring units in the number of n are the same or different and each denote a linear or branched C₂-C₄ alkylene group, R² denotes a C₁-C₉ alkyl group or a phenyl group, and n denotes an integer of 1 or more. 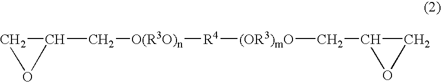
wherein R³'s in recurring units in the number of n and R³'s in recurring units in the number of m are the same or different and each denote a linear or branched C₂-C₄ alkylene group; R⁴ denotes a C₂-C₉ alkylene group, a phenylene group, —C₆H₄—CH₂—C₆H₄— or —C₆H₄—C(CH₃)₂—C₆H₄—; and n and m each denote an integer of 1 or more.

Concrete examples of compounds of the above-mentioned formula (2) include Denacol EX-931 (trademark; manufactured by Nagase Chemtex Corporation; weight average molecular weight: about 940), Glyciale PP-300 (trademark; manufactured by Sanyo Chemical Industries, Ltd.; weight average molecular weight: about 600), etc. 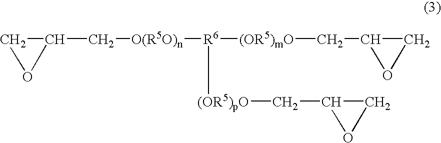
wherein R⁵'s in recurring units in the number of n, R⁵'s in recurring units in the number of m and R⁵'s in recurring units in the number of p are the same or different and each denote a linear or branched C₂-C₄ alkylene group; R⁶ denotes a C₂-C₆ alkanetriyl group; and n, m and p each denote an integer of 1 or more.

Amine compound (a₂) having active hydrogen includes aminosilane compounds, amine compounds which contain primary amino group and/or secondary amino group, and amine compounds which contain both primary amino group and/or secondary amino group and hydroxyl group.

Aminosilane compounds include compounds which have, in one molecule, at least one amino group and at least one group having formula (4) as follows: 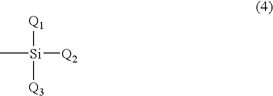
wherein Q₁, Q₂ and Q₃ each denote alkyl group, alkoxy group or alkylcarbonyloxy group with the proviso that at least one of Q₁, Q₂ and Q₃ is not an alkyl group.

Concrete examples of aminosilane compounds include compounds of formulae (5) to (7) as follows:

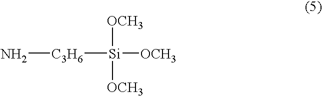

Examples of compounds of formula (5) above include KBM-903 (trademark; manufactured by Shin-etsu Chemical Co., Ltd.; weight average molecular weight: about 180).

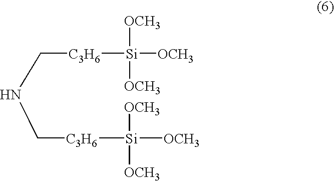

Examples of compounds of formula (6) above include X-12-666 (trademark; manufactured by Shin-etsu Chemical Co., Ltd.; weight average molecular weight: about 345).

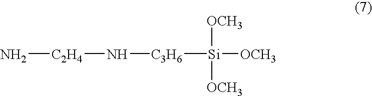

Examples of compounds of formula (7) above include KBM-603 (trademark; manufactured by Shin-etsu Chemical Co., Ltd.; weight average molecular weight: about 222).

Examples of amine compounds which contain primary amino group and/or secondary amino group, and of compounds which contain both primary amino group and/or secondary amino group and hydroxyl group include mono- or polyalkyl mono- or polyamines such as diethylamine, ethylenediamine, propylenediamine, diethylenetriamine, triethylenetetramine, butylenediamine, hexamethylenediamine, tetraethylenepentamine and pentaethylenehexamine; mono- or dialkanolamines such as monoethanolamine, diethanolamine, mono(2-hydroxypropyl)amine and di(2-hydroxypropyl)amine; alicyclic polyamines such as 1,3-bisaminomethylcylcohexanone and isophorone diamine; aromatic polyamines such as xylylenediamine, metaxylenediamine, diaminodiphenylmethane and phenylenediamine; nitrogen-containing heterocyclic compounds such as piperazine; and, as derived from these polyamines, other amine compounds such as polyamide, polyamideamine, amine adduct of epoxy compound, ketimine and aldimine.

These amine compounds (a₂) having active hydrogen may be used singly or in combination of two or more species.

Polyaddition compound (A) of this invention is produced by a ring-opening addition reaction between a glycidyl ether compound (a₁) having a polyoxyalkylene chain and an amine compound (a₂) having active hydrogen.

This ring-opening addition reaction is usually conducted by stirring either without solvent or in a suitable inert solvent, at a temperature of about 50 to about 130° C., preferably about 80 to about 120° C., for about 30 minutes to six hours, preferably about one to three hours.

The proportion of the use amount of glycidyl ether compound (a₁) having a polyoxyalkylene chain to that of amine compound (a₂) having active hydrogen is not strictly limited. Usually, however, 0.1 to 1.0 mole, especially 0.25 to 1.0 mole, more desirably 0.1 to 1.0 mole, of amine compound (a₂) having active hydrogen is preferably used per mole of glycidyl group of glycidyl ether compound (a₁) having a polyoxyalkylene chain.

Examples of usable solvent include hydrocarbon solvent such as toluene, xylene, cyclohexane and n-hexane; ester solvent such as methyl acetate, ethyl acetate and butyl acetate; ketone solvent such as acetone, methyl ethyl ketone, methyl isobutyl ketone and methyl amyl ketone; amide solvent such as dimethylformamide and dimethylacetamide; alcohol solvent such as methanol, ethanol, n-propanol and isopropanol; and mixtures thereof.

The above-mentioned reaction between glycidyl ether compound (a₁) having a polyoxyalkylene chain and amine compound (a₂) having active hydrogen where compound of the above-mentioned formula (1) and compound of the above-mentioned formula (5) are used as starting materials is illustrated by the following reaction formula:

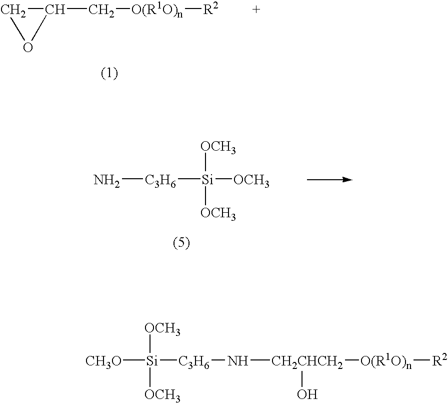

The above-mentioned reaction gives a polyaddition compound (A) having a polyoxyalkylene chain whose weight average molecular weight is in a range of 250 to 10,000, preferably 500 to 7,000, more desirably 1,000 to 4,000. When the weight average molecular weight of thus obtained polyaddition compound (A) exceeds 10,000, the stability of paint lowers in the case where said polyaddition compound is subjected to a long period of shear on a coating line. On the other hand, a weight average molecular weight of less than 250 gives insufficient paint surface-conditioning effect, and is liable to cause cissing on coating surface.

When, however, the weight average molecular weight of polyaddition compound (A) falls within the above-specified range, polyaddition compound (A) keeps stable even under a long period of shear by Filtration equipment or Ultra Filtration equipment on a coating line, and, thus, there occurs no trouble such as the clogging of Filtration equipment or Ultra Filtration equipment, or the adhesion of seeding bittness on coating surface.

Cationic Electrodeposition Paint:

Polyaddition compound (A) of this invention may be dispersed together with base resin, curing agent and other additive which are mentioned later to make emulsion, from which cationic electrodeposition paint is produced.

Alternatively, polyaddition compound (A) may be neutralized by organic acid such as acetic acid, formic acid or a mixture thereof, and then dispersed by the addition of water, to make aqueous dispersion (A₁). This aqueous dispersion (A₁) can be post-added to a bath of cationic electrodeposition paint which has been produced beforehand. Hence, for instance, aqueous dispersion (A₁) may be added during recess of coating line or on holiday. The above-mentioned organic acid may be used in an amount corresponding to 10 to 100 mgKOH, preferably 20 to 70 mgKOH, more desirably 30 to 50 mgKOH, per gram of resin solid content of polyaddition compound (A). When the use amount of organic acid is less than 10 mgKOH per gram of resin solid content, it becomes hard to disperse polyaddition compound (A) in water. Organic acid in an amount of more than 100 mgKOH, on the other hand, gives rise to the increase of acid concentration (MEQ) in cationic electrodeposition paint to which aqueous dispersion (A₁) has been added. This causes the decrease of Coulomb yield, which in turn is liable to bring about such problems that no film is formed even when electric current is applied, or that pinholes occur during the coating of galvanized alloy steel plate.

Cationic electrodeposition paint to which polyaddition compound (A) can be compounded or added in accordance with this invention preferably contains, for fundamental components, a cationic resin which is to be used as base resin and blocked polyisocyanate as a curing agent.

Cationic resin which is to be used as base resin has, in molecule, cationizable group such as amino group, ammonium base, sulfonium base and phosphonium base. As species of the resin, there may be included any type of resin that is usually employed as a base resin for electrocoating, e.g., resin of epoxy type, acrylic type, polybutadiene type, alkyd type and polyester type. Preferably in particular is amino group-containing epoxy resin which is produced by addition reaction of amino group-containing compound with polyepoxide compound.

Examples of the above-mentioned amino group-containing epoxy resin include (1) an adduct of polyepoxide compound with primary mono- or polyamine, secondary mono- or polyamine or with a mixture of primary and secondary polyamines (see, for instance, U.S. Pat. No. 3,984,299); (2) an adduct of polyepoxide compound with secondary mono- or polyamine which has a ketiminized primary amino group (see, for instance, U.S. Pat. No. 4,017,438); and (3) a product from an etherification reaction between polyepoxide compound and a hydroxyl compound which has a ketiminized primary amino group (see, for instance, Japanese Patent Application KOKAI Publication No. Sho 59-43013).

The above-mentioned polyepoxide compound which is used for the production of amino group-containing epoxy resin has at least one, preferably at least two, epoxy groups in a molecule. Suitable polyepoxide compound has a number average molecular weight in a range of generally at least 200, preferably 400 to 4,000, more desirably 800 to 2,500, and has an epoxy equivalent of at least 160, preferably 180 to 2,500, more desirably 400 to 1,500. In particular preferable is polyepoxide compound which is obtained from a reaction between polyphenol compound and epichlorohydrin.

As a polyphenol compound usable for the formation of said polyepoxide compound, there can be mentioned, for example, bis(4-hydroxyphenyl)-2,2-propane, 4,4′-dihydroxybenzophenone, bis(4-hydroxyphenyl)-1,1-ethane, bis(4-hydroxyphenyl)-1,1-isobutane, bis(4-hydroxy-2 or 3-tert-butyl-phenyl)-2,2-propane, bis(2-hydroxynaphthyl)methane, tetra(4-hydroxyphenyl)-1,1,2,2-ethane, 4,4′-dihydroxydiphenylsulfone, phenol novolac, cresol novolac, etc.

Said polyepoxide compound may have partially been made to react with polyol, polyether polyol, polyester polyol, polyamide amine, polycarboxylic acid or polyisocyanate compound, or may have had caprolactone such as ε-caprolactone or acrylic monomer grafted thereon.

Examples of primary mono- or polyamine, secondary mono- or polyamine and a mixture of primary and secondary polyamines which are used for the production of the above-mentioned amino group-containing epoxy resin (1) include mono- or dialkylamines such as monomethylamine, dimethylamine, monoethylamine, diethylamine, monoisopropylamine, diisopropylamine, monobutylamine, dibutylamine, etc.; mono- or dialkanolamines such as monoethanolamine, diethanolamine, mono(2-hydroxypropyl)amine, di(2-hydroxypropyl)amine, tri(2-hydroxypropyl)amine, monomethylaminoethanol, etc.; alkylenepolyamines such as ethylenediamine, propylenediamine, butylenediamine, hexamethylenediamine, tetraethylenepentamine, pentaethylenehexamine, diethylenetriamine, triethylenetetramine, etc.

Examples of secondary mono- or polyamine which has a ketiminized primary amino group used for the production of the above-mentioned amino group-containing epoxy resin (2) include ketiminized compounds which are produced by a reaction between a ketone compound and a compound having primary amino group (e.g., monomethylamine, monoethanolamine, ethylenediamine, diethylenetriamine, etc.) among primary mono- or polyamine, secondary mono- or polyamine and a mixture of primary and secondary polyamines which are used for the production of the above-mentioned amino group-containing epoxy resin (1).

Examples of a hydroxyl compound which has a ketiminized primary amino group used for the production of the above-mentioned amino group-containing epoxy resin (3) include hydroxyl group-containing ketiminized compounds which are produced by a reaction between a ketone compound and a compound having primary amino group and hydroxyl group (e.g., monoethanolamine, mono(2-hydroxypropyl)amine, etc.) among primary mono- or polyamine, secondary mono- or polyamine and a mixture of primary and secondary polyamines which are used for the production of the above-mentioned amino group-containing epoxy resin (1).

Preferable examples of the above-mentioned amino group-containing epoxy resin include the above-mentioned polyepoxide compound, a polyol compound which is obtained by the addition of caprolactone to a compound having at least two active hydrogen-containing groups in a molecule, and a polyol-modified amino group-containing epoxy resin which is obtained by the reaction of an amino group-containing compound.

Generally, the above-mentioned compound having at least two active hydrogen-containing groups in a molecule preferably has a molecular weight in a range of 62 to 5,000, and contains 2 to 30 active hydrogen-containing groups in a molecule. Examples of said active hydrogen-containing group include hydroxyl group, primary amino group and secondary amino group.

Concrete examples of the above-mentioned compound having at least two active hydrogen-containing groups in a molecule include low-molecular weight polyol such as ethylene glycol, propylene glycol, 1,3-butylene glycol, 1,4-butanediol, 1,6-hexanediol, diethylene glycol, dipropylene glycol, neopentyl glycol, glycerin, trimethylolpropane and pentaerythritol; linear or branched polyetherpolyol such as polyethylene glycol, polypropylene glycol, polytetramethylene glycol and bisphenol A polyethylene glycol ether; polyester polyol which is produced by polycondensation reaction between excessive organic diol such as the above-mentioned low-molecular weight polyol and organic dicarboxylic acid such as succinic acid, adipic acid, azelaic acid, sebacic acid, maleic acid, cyclohexanedicarboxylic acid, phthalic acid, isophthalic acid and terephthalic acid or anhydride thereof, amine compound such as butylenediamine, hexamethylenediamine, tetraethylenepentamine, pentaethylenehexamine, monoethanolamine, diethanolamine, triethanolamine, mono(2-hydroxypropyl)amine, di(2-hydroxypropyl)amine, 1,3-bisaminomethylcylcohexanone, isophorone diamine, xylylenediamine, metaxylenediamine, diaminodiphenylmethane, phenylenediamine, ethylenediamine, propylenediamine, diethylenetriamine and triethylenetetramine; nitrogen-containing heterocyclic compound such as piperazine; and, as derived from these amine compounds, polyamide, polyamideamine, amine adduct of epoxy compound, ketimine and aldimine.

Examples of caprolactone which is to be subjected to addition reaction with a compound having at least two active hydrogen-containing groups in a molecule include γ-caprolactone, ε-caprolactone and δ-caprolactone, among which ε-caprolactone is suitable.

Said addition reaction between a compound having at least two active hydrogen-containing groups and caprolactone may be conducted by any known method. This addition reaction gives a polyol compound.

Amino group-containing compound which is used for the production of the above-mentioned polyol-modified amino group-containing epoxy resin is a cationic property-imparting component by which to introduce amino group into, and cationize, a resin. Amino group-containing compound having at least one active hydrogen which reacts with epoxy group is usable for this purpose.

Concrete examples of such an amino group-containing compound include primary mono- or polyamine, secondary mono- or polyamine or a mixture of primary and secondary polyamines which is used for the production of the above-mentioned amino group-containing epoxy resin (1); secondary mono- or polyamine which has a ketiminized primary amino group which is used for the production of the above-mentioned amino group-containing epoxy resin (2); and a hydroxyl compound which has a ketiminized primary amino group which is used for the production of the above-mentioned amino group-containing epoxy resin (3).

Generally, cationic resin has a number average molecular weight preferably in a range of 700 to 6,000, especially 850 to 5,000, more desirably 1,000 to 4,000, and has cationic group preferably in a range of 0.5 to 3 equivalents, especially 0.6 to 2.5 equivalents, more desirably 0.7 to 2 equivalents, per kilogram of resin.

Cationic resin which has amino group as a cationizable group can be rendered water-soluble or water-dispersible when neutralized with acid like organic carboxylic acid such as formic acid, acetic acid, propionic acid and lactic acid; and inorganic acid such as hydrochloric acid and sulfuric acid. Cationic resin which has an onium base such as ammonium base, sulfonium base or phosphonium base as a cationizable group, on the other hand, can be rendered water-soluble or water-dispersible without neutralization.

Cationic resin may be used in the form of aqueous solution or aqueous dispersion, or in the form of organic solvent solution. Cationic resin which has been neutralized with acid, and dissolved or dispersed in an aqueous medium, is usable for cationic electrodeposition coating.

As a base resin, xyleneformaldehyde resin-modified amino group-containing epoxy resin may be usable. Xyleneformaldehyde resin-modified amino group-containing epoxy resin includes amino group-containing epoxy resin which is obtained from a reaction of epoxy resin having an epoxy equivalent of 180 to 3,000, xyleneformaldehyde resin and amino group-containing compound.

Epoxy resin similar to those which have been referred to with regard to the above-mentioned cationic resin is suitably used as a starting material for the production of the above-mentioned amino group-containing epoxy resin.

Xyleneformaldehyde resin serves to internally plasticize (modify) epoxy resin, and is produced by condensation reaction of xylene, formaldehyde and optionally phenols in the presence of an acidic catalyst.

The above-mentioned formaldehyde is exemplified by industrially available compounds which generate formaldehyde, such as formalin, paraformaldehyde and trioxane.

The above-mentioned phenols include monovalent or divalent phenolic compounds which have two or three reactive sites. Concrete examples are phenol, cresol, para-octylphenol, nonyl phenol, bisphenol propane, bisphenol methane, resorcin, pyrocatechol, hydroquinone, para-tert-butylphenol, bisphenol sulfone, bisphenol ether and para-phenylphenol, which can be used singly or in combination of two or more species. Among these, phenol and cresol are suitable.

Examples of the above-mentioned acidic catalyst which is used for condensation reaction of xylene, formaldehyde and optionally phenols include sulfuric acid, hydrochloric acid, paratoluenesulfonic acid and oxalic acid, among which sulfuric acid is in particular preferable.

Condensation reaction is conducted by heating to a temperature at which xylene, phenols, water, formalin, or the like., which exists in the reaction system is refluxed, usually to about 80 to about 100° C., and is finished within about two to six hours.

Xyleneformaldehyde resin is produced from a reaction, with heating, of xylene, formaldehyde and optionally phenols in the presence of an acidic catalyst.

Thus produced xyleneformaldehyde resin has generally a viscosity in a range of 20 to 50,000 cP (25° C.), preferably 25 to 35,000 cP (25° C.), more desirably 30 to 15,000 cP (25° C.), and has preferably a hydroxyl equivalent in a range of 100 to 50,000, especially 150 to 30,000, more desirably 200 to 10,000.

Amino group-containing compound is a cationic property-imparting component by which to introduce amino group into, and cationize, an epoxy resin. Those amino group-containing compounds which are used for the production of the above-mentioned cationic resin are usable for this purpose.

The above-mentioned reaction of epoxy resin with xyleneformaldehyde resin and amino group-containing compound can be conducted in any order. Generally, xyleneformaldehyde resin and amino group-containing compound are preferabaly made to react simultaneously with epoxy resin.

The above-mentioned addition reaction is usually conducted in a suitable solvent at a temperature of about 80 to about 170° C., preferably about 90 to about 150° C., for about one to six hours, preferably for one to five hours. As the above-mentioned solvent, there can be mentioned, for example, hydrocarbons such as toluene, xylene, cyclohexane, n-hexane, etc.; esters such as methyl acetate, ethyl acetate, butyl acetate, etc.; ketones such as acetone, methyl ethyl ketone, methyl isobutyl ketone, methyl amyl ketone, etc.; amides such as dimethylformamide, dimethylacetamide, etc.; alcohols such as methanol, ethanol, n-propanol, isopropanol, etc.; and mixtures thereof.

The proportion of components for the above-mentioned addition reaction is not strictly limited, but changeable appropriately. However, the following proportion based upon the total solid content weight of the three components, i.e., epoxy resin, xyleneformaldehyde resin and amino group-containing compound, is suitable: 50 to 90% by weight, preferably 50 to 85% by weight, of epoxy resin; 5 to 45% by weight, preferably 6 to 43% by weight, of xyleneformaldehyde resin; and 5 to 25% by weight, preferably 6 to 20% by weight, of amino group-containing compound.

As a curing agent which is to be used with base resin, a blocked polyisocyanate compound which is a product from addition reaction of a polyisocyanate compound and a blocking agent in an approximately stoichiometric amount is preferable from the viewpoint of curability and corrosion resistance.

As the above-mentioned polyisocyanate compound, conventional ones are usable. There can be mentioned, for example, aromatic, aliphatic or alicyclic polyisocyanate compounds such as tolylene diisocyanate, xylylene diisocyanate, phenylene diisocyanate, diphenylmethane-2,4′-diisocyanate, diphenylmethane-4,4′-diisocyanate (usually referred to as MDI), crude MDI, bis(isocyanatomethyl)cyclohexane, tetramethylene diisocyanate, hexamethylene diisocyanate, methylene diisocyanate, isophoron diisocyanate, etc.; cyclized polymer and isocyanatobiuret of these polyisocyanate compounds; and isocyanate-terminated compounds obtained by a reaction of an excess amount of a polyisocyanate compound as mentioned above with a low molecular active hydrogen-containing compound such as ethylene glycol, propylene glycol, trimethylolpropane, hexanetriol, castor oil, etc. These compounds can be used either singly or in combination of two or more kinds.

Blocking agent, on the other hand, is added to, and blocks, isocyanate group of a polyisocyanate compound. Blocked polyisocyanate compound as formed by this addition is desirably stable at normal temperature, and capable of dissociating a blocking agent when heated to a baking temperature (usually about 100 to about 200° C.) of coating film to reproduce a free isocyanate group.

As a blocking agent meeting such requirements, there can be mentioned, for example, lactam type compounds such as ε-caprolactam, γ-butyrolatam, etc.; oxime type compounds such as methyl ethyl ketoxime, cyclohexanone oxime, etc.; phenol type compounds such as phenol, p-t-butylphenol, cresol, etc.; aliphatic alcohols such as n-butanol, 2-ethylhexanol, etc.; aromatic alkyl alcohols such as phenylcarbinol, methylphenylcarbinol, etc.; ether alcohol type compounds such as ethylene glycol monobutyl ether, diethylene glycol monoethyl ether, etc.

Apart from the above-mentioned blocking agent, there can be used, as a curing agent, a blocked polyisocyanate which is made from, as a blocking agent, diol with a molecular weight of 76 to 150 having two hydroxyl groups which are different in reactivity from each other, or from carboxyl group-containing diol with a molecular weight of 106 to 500.

The above-mentioned diol may have two hydroxyl groups which are different in reactivity from each other, e.g., primary and secondary hydroxyl groups, primary and tertiary hydroxyl groups, or secondary and tertiary hydroxyl groups, and have a molecular weight of 76 to 150.

Examples of such diol include propylene glycol, dipropylene glycol, 1,3-butanediol, 1,2-butanediol, 3-methyl- 1,2-butanediol, 1,2-pentanediol, 1,4-pentanediol, 3-methyl-4,3-pentanediol, 3-methyl-4,5-pentanediol, 2,2,4-trimethyl-1,3-pentanediol, 1,5-hexanediol and 1,4-hexanediol, each of which has two hydroxyl groups which are different in reactivity from each other. Among these, propylene glycol is preferable from the viewpoint of reactivity for blocked polyisocyanate, the decrease of heat loss and the storage stability of paint. In the above-mentioned diols, hydroxyl group with higher reactivity reacts earlier with isocyanate group to block the same.

The above-mentioned carboxyl group-containing diol includes those with a molecular weight of 106 to 500. In said diols, carboxyl group in a molecule improves low-temperature dissociability, and thus improves low-temperature curability. In particular when organotin compound is used as a curing catalyst, low-temperature curability is remarkably improved.

Examples of carboxyl group-containing diol include 2,2-dimethylolpropionic acid, 2,2-dimethylolbutanoic acid, dimethylolvaleric acid, glyceric acid, etc.

The above-mentioned base resin and curing agent are used in the following proportion: Base resin is used in a range of 50 to 95% by weight, especially 60 to 90% by weight, more desirably 65 to 85% by weight, based on the total solids content of base resin and curing agent; curing agent is used in a range of 5 to 50% by weight, especially 10 to 40% by weight, more desirably 15 to 35% by weight, based on the total solids content of base resin and curing agent.

Cationic electrodeposition paint contains base resin and curing agent at a concentration of 10 to 40% by weight, especially 10 to 30% by weight, more desirably 15 to 25% by weight, as a total solids content.

Cationic electrodeposition paint contains not only fundamental two components of base resin and curing agent but also, optionally, other additives for paint such as color pigment, extender pigment, anticorrosive pigment, organic solvent, pigment dispersing agent, surface adjustment agent, surfactant, acid, catalyst, etc., in an amount which is usually employed.

Polyaddition compound (A) of this invention as mentioned above may be blended with components for cationic electrodeposition paint at any stage of preparation of cationic electrodeposition paint (hereinafter referred to as “pre-addition method”), or with cationic electrodeposition paint which has been prepared beforehand (hereinafter referred to as “post-addition method”).

In pre-addition method, polyaddition compound (A) is dispersed into an aqueous medium together with a base resin, a curing agent and optionally with other additive for paint to make emulsion. Then, with use of said emulsion and a pigment-dispersed paste, cationic electrodeposition paint is produced.

In the above-mentioned production of emulsion, polyaddition compound (A), a base resin, a curing agent and optionally other additive for paint are put together and mixed well to form a varnish solution. To the varnish solution, a neutralizing agent selected from formic acid, acetic acid, lactic acid, propionic acid, citric acid, malic acid, sulfamic acid and a mixture of two or more thereof, is added in an aqueous medium to form an aqueous dispersion, which is usable as an emulsion for cationic electrodeposition paint.

Polyaddition compound (A) is preferably blended in an amount of 0.1 to 20 parts by weight, especially 0.5 to 15 parts by weight, more desirably 1 to 10 parts by weight, as solid content, per 100 parts by weight of total solid content of base resin and curing agent, from the viewpoint of paint stability or the like.

In post-addition method, organic acid such as acetic acid, formic acid or lactic acid is added, in an amount corresponding to 10 to 100 mgKOH, preferably 20 to 70 mgKOH, more desirably 30 to 50 mgKOH, to polyaddition compound (A) per gram of the solid content of polyaddition compound (A), by which to water-solubilize polyaddition compound (A), and, thus, an aqueous dispersion of polyaddition compound (A) is prepared.

Apart from the above, a neutralizer is added to the above-mentioned base resin, curing agent and optionally other additive for paint to disperse them in water, and, thus, an emulsion is prepared. Then, a pigment-dispersed paste is added to the emulsion, and the resultant mixture is diluted with aqueous medium where necessary, and, thus, cationic electrodeposition paint is produced.

To the cationic electrodeposition paint which has thus been produced beforehand, the above-mentioned aqueous dispersion of polyaddition compound (A) is added in an amount of 0.1 to 20 parts by weight, especially 0.5 to 15 parts by weight, more desirably 1 to 10 parts by weight, as solid content, per 100 parts by weight of total solid content of base resin and curing agent, and, thus, cationic electrodeposition paint of this invention is produced. Polyaddition compound (A) may be added at the stage of cationic electrocoating.

Cationic electrodeposition paint of this invention can be applied onto any desired substrate by cationic electrocoating.

Electrocoating can be conducted generally in an electrodeposition bath which has been diluted with deionized water etc. so that the solid content of the bath may become about 5 to about 40% by weight, and pH of which has been adjusted to fall in the range of 5.5 to 9.0, usually under the condition of bath temperature of about 15 to about 35° C. and load voltage at 100 to 450V.

The film thickness of the electrodeposition coating film formed by using the electrodeposition paint of this invention is not particularly limited, but is generally in the range of 10 to 40 μm, preferably 10 to 25 μm, as a cured coating film. The baking temperature of the coating film is generally in the range of about 120 to about 200° C., preferably about 140 to about 180° C., at the surface of substrate. The baking time is about 5 to 60 minutes, preferably about 10 to 30 minutes.

Cationic electrodeposition paint of this invention which contains polyaddition compound (A) is excellent in coating workability such as appearance, oil-cissing resistance, water mark insensibility and contamination resistance, and in adhesion to topcoat coating film. In particular when automobile body of a complicated shape is to be coated on a line, polyaddition compound (A) of this invention can be added, as an aqueous dispersion, directly into a paint tank at the time when the operation of coating line is suspended (e.g., at break, at recess for shift change, holiday, etc.), which makes it very easy to improve or adjust coating workability.

When the content of pigment in cationic electrodeposition paint is lowered to 5 to 18% by weight, cissing tends to occur on coating surface while paint is improved in sedimentation property and re-dispersibility. Polyaddition compound (A), on the other hand, does not reduce the corrosion resistance of coating film, and can therefore be added in a range of amount as wide as from 0.1 to 20 parts by weight, which remarkably serves to improve coating workability.

In the following, the present invention is described more specifically by working examples. The present invention is, however, not to be restricted to these examples alone. Incidentally, “Part” and “%” means “part by weight” and “% by weight”, respectively.

Production of Polyaddition Compound (A):

### Production Example 1

A reactor was fed with 260 parts of a compound (glycidyl ether compound having a weight average molecular weight of about 2,600) of the following formula (8): 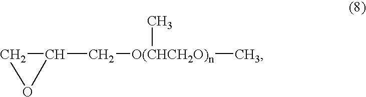
18 parts of KBM-903 (trademark of γ-aminopropyltrimethoxysilane manufactured by Shin-etsu Chemical Co., Ltd.; molecular weight: about 180) and 70 parts of ethylene glycol monobutyl ether, and the temperature was raised to 80° C. While this temperature was maintained, the resultant mixture was stirred for three hours to give Polyaddition compound No. 1 which had a resin solids content of 80%, a weight average molecular weight of 2,780 and an amine value of 20 mgKOH/g.

### Production Example 2

A reactor was fed with 260 parts of a compound (glycidyl ether compound having a weight average molecular weight of about 2,600) of the following formula (9): 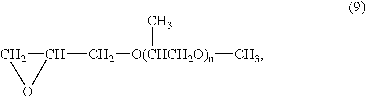
2.2 parts of KBM-603 (trademark of N-β (aminoethyl) γ-aminopropyltrimethoxysilane manufactured by Shin-etsu Chemical Co., Ltd.; molecular weight: about 222), 7.4 parts of diethanolamine and 67 parts of ethylene glycol monobutyl ether, and the temperature was raised to 120° C. While this temperature was maintained, the resultant mixture was stirred for three hours to give Polyaddition compound No. 2 which had a resin solids content of 80%, a weight average molecular weight of 2,690 and an amine value of 19 mgKOH/g.

### Production Example 3

A reactor was fed with 260 parts of a compound (glycidyl ether compound having a weight average molecular weight of about 2,600) of the following formula (10): 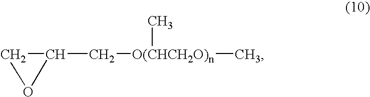
34 parts of X-12-666 (trademark of bis[3-(trimethoxysilyl)propyl]amine manufactured by Shin-etsu Chemical Co., Ltd.; weight average molecular weight: about 341) and 33 parts of ethylene glycol monobutyl ether, and the temperature was raised to 120° C. While this temperature was maintained, the resultant mixture was stirred for three hours to give Polyaddition compound No. 3 which had a resin solids content of 90%, a weight average molecular weight of 2,940 and an amine value of 19 mgKOH/g.
Production of Aqueous Dispersion

### Production Example 4

To 348 parts of Polyaddition compound No. 1 which had been obtained in Production Example 1, there were added 6 parts of acetic acid (corresponding to 20 mgKOH per gram of total resin solid content) and 1,036 parts of water to give Aqueous dispersion No. 1 whose solids content was 20%.

### Production Example 5

To 336.6 parts of Polyaddition compound No. 2 which had been obtained in Production Example 2, there were added 5.5 parts of acetic acid (corresponding to 19 mgKOH per gram of total resin solid content) and 1,006 parts of water to give Aqueous dispersion No. 2 whose solids content was 20%.

### Production Example 6

A reactor was fed with 320 parts of isopropylalcohol, temperature of which was raised to reflux temperature (about 83° C.) with stirring. To this isopropylalcohol, a mixture of the following monomers and polymerization initiator:

| | |
|---|---|
| styrene | 272 parts |
| n-butylacrylate | 224 parts |
| 2-hydroxyethyl acrylate | 80 parts |
| dimethylaminoethyl methacrylate | 144 parts |
| KBM-503 (trademark of γ-(meth)acryloyloxy- | 80 parts |
| propyltrimethoxysilane manufactured by | |
| Shin-etsu Chemical Co., Ltd.; molecular | |
| weight: about 250) | |
| azobisisobutyronitrile | 24 parts, |

was added dropwise at a reflux temperature (about 83 to 87° C.) in a period of about two hours.

The resultant mixture was further stirred for 30 minutes, and, then, a solution of eight parts of azobisdimethylvaleronitrile in 120 parts of isopropylalcohol was added dropwise to said mixture in a period of about one hour. After the resultant mixture was stirred for about one hour, 320 parts of isopropylalcohol was added, and, then, the resultant mixture was cooled. Thus, there was obtained a varnish of acrylic copolymer which had a solids content of 51%, an amine value of 64 mgKOH/g, a hydroxyl value of 48 mgKOH/g and a number average molecular weight of about 20,000.

Subsequently, 6.4 parts of acetic acid was added to 780 parts of the above-mentioned varnish of acrylic copolymer, and, then, the resultant mixture was stirred at about 30° C. for five minutes. To said mixture, 1,156 parts of deionized water was added dropwise in a period of about 30 minutes with vigorous stirring to give Aqueous dispersion No. 3 of milky white color whose solids content was 20%.

### Production Example 7

### Production Example of Base Resin No. 1

A separable flask of inner volume of 2 liters which was equipped with thermometer, reflux condenser and stirrer was fed with 240 g of 50% formalin, 55 g of phenol, 101 g of 98% industrial sulfuric acid and 212 g of m-xylene, and, then, the resultant mixture was allowed to react at 84 to 88° C. for four hours. After the reaction was over, the mixture was left to stand still so that resin phase and aqueous sulfuric acid phase might be separated from each other. The resin phase was washed with water three times, and, under a condition of 20-30 mmHg/120-130° C., unreacted m-xylene was stripped out for 20 minutes, and, thus, xylene-formaldehyde resin (1) with a viscosity of 1,050 cP (25° C.) was obtained.

Another flask was fed with 1,000 g of Epikote 828EL (tradename of epoxy resin manufactured by Japan Epoxy Resin Co., Ltd.; epoxy equivalent: 190; molecular weight: 350), 400 g of bisphenol A and 0.2 g of dimethylbenzylamine, and the resultant mixture was allowed to react at 130° C. until epoxy equivalent became 750.

Then, 300 g of the above-mentioned xylene-formaldehyde resin. (1), 140 g of diethanolamine and 65 g of ketiminized diethylenetriamine were added, and the resultant mixture was allowed to react at 120° C. for four hours. Thereafter, 420 g of ethylene glycol monobutyl ether was added, and, thus, there was obtained Base resin No. 1 as a xylene-formaldehyde resin-modified amino group-containing epoxy resin which had an amine value of 52 mgKOH/g and a resin solids content of 80%.

### Production Example 8

### Production Example of Base Resin No. 2

There was added 300 g of ε-caprolactone to 400 g of PP-400 (trademark of polypropylene glycol manufactured by Sanyo Chemical Industries, Ltd.; molecular weight: 400), and, then, the temperature of the resultant mixture was raised to 130° C. Subsequently, 0.01 g of tetrabutoxy titanium was added, and temperature was raised to 170° C. Sampling was conducted with time while this temperature was maintained, and the amount of unreacted ε-caprolactone was monitored by infrared absorption spectrum measurement. When the reaction rate became 98% or more, the reaction mixture was cooled to give modifier 1.

Apart from the above, 400 g of bisphenol A and 0.2 g of dimethylbenzylamine were added to 1,000 g of Epikote 828EL (tradename of epoxy resin manufactured by Japan Epoxy Resin Co., Ltd.; epoxy equivalent: 190; molecular weight: 350), and the resultant mixture was allowed to react at 130° C. until epoxy equivalent became 750.

To the above-mentioned mixture, 120 g of nonyl phenol was added, and the resultant mixture was allowed to react at 130° C. until epoxy equivalent became 1,000. Then, 200 g of modifier 1, 95 g of diethanolamine and 65 g of ketiminized diethylenetriamine were added, and the resultant mixture was allowed to react at 120° C. for four hours. Thereafter, 414 g of ethylene glycol monobutyl ether was added, and, thus, there was obtained Base resin No. 2 as a nonyl phenol-containing polyol-modified amino group-containing epoxy resin which had an amine value of 40 mgKOH/g and a resin solids content of 80%

### Production Example 9

### Production Example of Curing Agent

To 270 g of Cosmonate M-200 (trade name of crude MDI made by Mitsui Chemicals, Inc.), 46 g of methyl isobutyl ketone was added, and temperature was raised to 70° C. Then, after 281 g of diethylene glycol monoethyl ether was slowly added, temperature was raised to 90° C. Sampling was conducted with time while this temperature was maintained, and, when no absorption of unreacted isocyanate was observed any more by infrared absorption spectrum measurement of samples, reaction was stopped, and the amount of solvent was adjusted, and, thus, there was obtained a blocked polyisocyanate type curing agent having a solids content of 90%.

### Production Example 10

### Production of Emulsion No. 1

There were blended 6.25 parts (solids content: five parts) of Polyaddition compound No. 1 obtained in Production Example 1, 87.5 parts (solids content: 70 parts) of Base resin No. 1 obtained in Production Example 7, 33.3 parts (solids content: 30 parts) of Curing agent obtained in Production Example 9 and 8.2 parts of 10% formic acid. The resultant mixture was stirred homogeneously, and, then, 173.8 parts of deionized water was added dropwise in a period of about 15 minutes with vigorous stirring, and, thus, there was obtained Emulsion No. 1 for cationic electrodeposition paint which had a solids content of 34%.

### Production Examples 11-14

### Production of Emulsion Nos. 2-5

Emulsion Nos. 2-5 for cationic electrodeposition paint were obtained in the same manner as in Production Example 10 in accordance with the formulation as shown in Table 1.

TABLE 1

| Production | Production | Production | Production | Production |
|---|---|---|---|---|
| Example | Example | Example | Example | Example |
| 10 | 11 | 12 | 13 | 14 |

| Emulsion | | No. 1 | No. 2 | No. 3 | No. 4 | No. 5 |
|---|---|---|---|---|---|---|
| Polyaddition | 80% Polyaddition | 6.25 | | | | |
| compound (A) | compound No. 1 | (5) | | | | |
| | 80% Polyaddition | | 6.25 | | | |
| | compound No. 2 | | (5) | | | |
| | 80% Polyaddition | | | 6.25 | | |
| | compound No. 3 | | | (5) | | |
| Surface treating | Sunnix PP-1000 | | | | | 5 |
| agent | (Note 1) | | | | | (5) |
| Base resin (B) | 80% Base resin | 87.5 | 87.5 | | 87.5 | 87.5 |
| | No. 1 | (70) | (70) | | (70) | (70) |
| | 80% Base resin | | | 87.5 | | |
| | No. 2 | | | (70) | | |
| Curing agent | 90% Curing agent | 33.3 | 33.3 | 33.3 | 33.3 | 33.3 |
| (C) | | (30) | (30) | (30) | (30) | (30) |

| | | | | | |
|---|---|---|---|---|---|
| 10% Formic acid | 8.2 | 8.2 | 8.2 | 8.2 | 8.2 |
| Deionized water | 173.8 | 173.8 | 173.8 | 165 | 175 |
| 34% Emulsion | 309 | 309 | 309 | 294 | 309 |
| | (105) | (105) | (105) | (100) | (105) |

(Solids content)
(Note 1)
Sunnix PP-1000: trademark of polypropylene glycol manufactured by Sanyo Chemical Industries, Ltd.

### Production Example 15

### Production Example of Pigment-Dispersed Paste

There were blended 5.83 parts (solids content: 3.5 parts) of 60% quaternary ammonium salt type epoxy resin, 14.5 parts of titanium white, 0.3 part of carbon black, 7.0 parts of extender pigment, 1.0 part of bismuth hydroxide, 1.0 part of dioctyltin oxide and 20 parts of deionized water, and, thus, there was obtained pigment-dispersed paste with a solids content of 55.0% by weight.

### EXAMPLES AND COMPARATIVE EXAMPLES

### Example 1

### Production Example of Cationic Electrodeposition Paint No. 1

To 309 parts (solids content: 105 parts) of Emulsion No. 1 for cationic electrodeposition paint, there were added 49.6 parts (solids content: 27.3 parts) of the pigment-dispersed paste and 173.8 parts of deionized water, and, thus, there was obtained Cationic electrodeposition paint No. 1 with a solids content of 20%.

### Examples 2-5 and Comparative Examples 1-3

In the same manner as in Example 1, Cationic electrodeposition paint Nos. 2-8 of Examples 2-5 and Comparative Examples 1-3 were obtained in accordance with the formulation as shown in Table 2.

TABLE 2

| | | Ex. 1 | Ex. 2 | Ex. 3 | Ex. 4 | Ex. 5 | C. Ex. 1 | C. Ex. 2 | C. Ex. 3 |
|---|---|---|---|---|---|---|---|---|---|
| Cationic electrodeposition | | | | | | | | | |
| paint | | | | | | | | | |
| Paint | Emulsion No. 1 | 309 | | | | | | | |
| formulation | (Polyaddition | (105) | | | | | | | |
| | compound | | | | | | | | |
| | No. 1) | | | | | | | | |
| | Emulsion No. 2 | | 309 | | | | | | |
| | (Polyaddition | | (105) | | | | | | |
| | compound | | | | | | | | |
| | No. 2) | | | | | | | | |
| | Emulsion No. 3 | | | 309 | | | | | |
| | (Polyaddition | | | (105) | | | | | |
| | compound | | | | | | | | |
| | No. 3) | | | | | | | | |
| | Emulsion No. 4 | | | | 294 | 294 | 294 | 294 | |
| | | | | | (100) | (100) | (100) | (100) | |
| | Emulsion No. 5 | | | | | | | | 309 |
| | (PP-1000) | | | | | | | | (105) |
| | Pigment-dispersed | 49.6 | 49.6 | 49.6 | 49.6 | 49.6 | 49.6 | 49.6 | 49.6 |
| | paste | (27.3) | (27.3) | (27.3) | (27.3) | (27.3) | (27.3) | (27.3) | (27.3) |
| | Deionized water | 302 | 302 | 302 | 293 | 293 | 293 | 293 | 302 |
| | 20% Bath | 661 | 661 | 661 | 637 | 637 | 637 | 637 | 661 |
| | | (132.3) | (132.3) | (132.3) | (127.3) | (127.3) | (127.3) | (127.3) | (132.3) |
| Aqueous | 20% Aqueous dispersion | | | | 25 | | | | |
| dispersion | No. 1 | | | | (5) | | | | |
| | 20% Aqueous dispersion | | | | | 25 | | | |
| | No. 2 | | | | | (5) | | | |
| | 20% Aqueous dispersion | | | | | | | 25 | |
| | No. 3 | | | | | | | (5) | |

Ex.: Example
C. Ex.: Comparative Example

Preparation of Test Plates

Cold-rolled dull steel plate and zinc-plated steel plate each of the size of 150 mm×70 mm×0.8 mm which had been chemically treated with Palbond #3020 (trade name of a zinc phosphate treating agent made by Nihon Parkerizing Company) was coated with cationic electrodeposition paint obtained in the above-mentioned Examples and Comparative Examples. So formed electrodeposition coating film was baked at 170° C. for 20 minutes in an electric hot air drier, and, thus, test plates were obtained.

The test plates were subjected to tests under the following test conditions. Results are shown in Table 3.

TABLE 3

| | | Ex. 1 | Ex. 2 | Ex. 3 | Ex. 4 | Ex. 5 | C. Ex. 1 | C. Ex. 2 | C. Ex. 3 |
|---|---|---|---|---|---|---|---|---|---|
| Cationic electrodeposition paint | | No. 1 | No. 2 | No. 3 | No. 4 | No. 5 | No. 6 | No. 7 | No. 8 |
| Test Results | Appearance (Note 2) | ◯ | ◯ | ◯ | ◯ | ◯ | ◯ | ◯ | ◯ |
| | Oil-cissing resistance (Note 3) | ◯ | ◯ | ◯ | ◯ | ◯ | X | ◯ | ◯ |
| | Water mark insensibility (Note 4) | ◯ | ◯ | ◯ | ◯ | ◯ | Δ | Δ | Δ |
| | Sealer adhesion (Note 5) | ◯ | ◯ | ◯ | ◯ | ◯ | ◯ | Δ | Δ |
| | Corrosion resistance (Note 6) | ◯ | ◯ | ◯ | ◯ | ◯ | ◯ | Δ | Δ |
| | Paint stability (Note 7) | ◯ | ◯ | ◯ | ◯ | ◯ | ◯ | Δ | Δ |
| (Note 2) | | | | | | | | | |
| Appearance: The surface roughness of outer surface of electrodeposition coating film was measured by Surftest 301 (trademark of surface roughness tester made by Mitutoyo Corporation), and, thus, Ra value was determined. | | | | | | | | | |
| ◯: Ra value was less than 0.25 μm. | | | | | | | | | |
| Δ: Ra value was 0.25 μm or more, and less than 0.35 μm. | | | | | | | | | |
| X: Ra value was more than 0.35 μm. | | | | | | | | | |
| (Note 3) | | | | | | | | | |
| Oil-cissing resistance: On a wet plate after coated with electrodeposition paint, a crown cap which contained 1 ml of machine oil was placed. After baking at 170° C. for 20 minutes, coating surface was observed. | | | | | | | | | |
| ◯: In a good state; neither depression nor cissing was observed. | | | | | | | | | |
| Δ: Depressions were found here and there on a part of coating surface. | | | | | | | | | |
| X: On the whole of coating surface, there were found cissings which reached to the substrate. | | | | | | | | | |
| (Note 4) | | | | | | | | | |
| Water mark insensibility: On a wet plate after coated with electrodeposition paint, 1 ml of deionized water was dropped, and, then, the coated plate was baked. | | | | | | | | | |
| ◯: No problem in appearance; almost no water mark was observed. | | | | | | | | | |
| Δ: Appearance was poor; some water marks were observed. | | | | | | | | | |
| X: Appearance was remarkably poor; water marks were distinctly observed. | | | | | | | | | |
| (Note 5) | | | | | | | | | |
| Sealer adhesion: Each of the test plates were coated with Sunstar 1065T (trademark of a sealer made by Sunstar Inc.) in an area of 10 mm × 6 mm × 6 mm (length × width × thickness), and thus coated plates were hung vertically. After 12 hours, it was measured how much the sealer had slid. | | | | | | | | | |
| ◯: No problem; sealer had not slid down at all. | | | | | | | | | |
| Δ: Sealer had slid 5 mm or less. | | | | | | | | | |
| X: Sealer had slid off the coated plate. | | | | | | | | | |
| (Note 6) | | | | | | | | | |
| Corrosion resistance: Cross-cut scratches were made on electrodeposition coating film which had been obtained by baking, at 170° C. for 20 minutes, of electrodeposition paint on each of the electrodeposition coated plates (chemically treated zinc-plated steel plates), with a knife so that the scratches might reach the substrate. Thus treated plates were subjected to salt water spray | | | | | | | | | |
| # tests according to JIS Z-2371 for 840 hours, and evaluated by the width of rust and blister from the knife scratch. | | | | | | | | | |

◯: Width of rust or blister was less than 3 mm (one side).
Δ: Width of rust or blister was 3-4 mm (one side).
X: Width of rust or blister was more than 4 mm (one side).
(Note 7)
Paint stability: After circulated with Labo pump at 30° C. for 12 hours, paint was filtered with a 400-mesh filter, and, thus, the amount of filter residue was measured.
◯: 10 mg/L or less
Δ: 11-20 mg/L
X: more than 20 mg/L

1. A polyaddition compound of a glycidyl ether compound (a₁) having a polyoxyalkylene chain with an amine compound (a₂) having at least one active hydrogen, which has a weight average molecular weight of 250-10,000.

2. A polyaddition compound of claim 1 wherein glycidyl ether compound (a₁) having a polyoxyalkylene chain has formula (1) as follows: 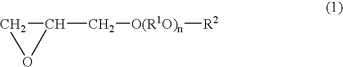
wherein RI's in recurring units in the number of n are the same or different and each denote a linear or branched C₂-C₄ alkylene group, R² denotes a C₁-C₉ alkyl group or a phenyl group, and n denotes an integer of 1 or more.

3. A polyaddition compound of claim 1 wherein glycidyl ether compound (a1) having a polyoxyalkylene chain has formula (2) as follows: 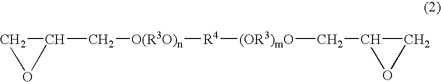
wherein R³'s in recurring units in the number of n and R³'s in recurring units in the number of m are the same or different and each denote a linear or branched C₂-C₄ alkylene group; R⁴ denotes a C₂-C₉ alkylene group, a phenylene group, —C₆H₄—CH₂—C₆H₄— or —C₆H₄—C(CH₃)₂—C₆H₄—; and n and m each denote an integer of 1 or more.

4. A polyaddition compound of claim 1 wherein glycidyl ether compound (a) having a polyoxyalkylene chain has formula (3) as follows: 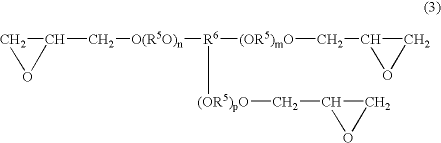
wherein R⁵'s in recurring units in the number of n, R⁵'s in recurring units in the number of m and R⁵'s in recurring units in the number of p are the same or different and each denote a linear or branched C₂-C₄ alkylene group; R⁶ denotes a C₂-C₆ alkanetriyl group; and n, m and p each denote an integer of 1 or more.

5. A polyaddition compound of claim 1 wherein amine compound (a₂) having active hydrogen is an aminosilane compound.

6. A polyaddition compound of claim 1 wherein amine compound (a₂) having active hydrogen is an amine compound which contains primary amino group and/or secondary amino group, or an amine compound which contains both primary amino group and/or secondary amino group and hydroxyl group.

7. A polyaddition compound of claim 1 which has a weight average molecular weight in a range of 500 to 7,000.

8. A polyaddition compound of claim 1 which is produced by a ring-opening addition reaction of 0.1 to 1.0 mole of amine compound (a₂) having active hydrogen per mole of glycidyl group of glycidyl ether compound (a₁) having a polyoxyalkylene chain.

9. Cationic electrodeposition paint which comprises, as a base resin, amino group-containing epoxy resin produced from an addition reaction between epoxy resin and amino group-containing compound, and, as a curing agent, a blocked polyisocyanate compound, and, blended thereto at any stage of preparation, also a polyaddition compound of claim 1 in the proportion of 0.1-20 parts by weight, as a solid content, per 100 parts by weight of total solid content of base resin and curing agent.

10. Cationic electrodeposition paint of claim 9 which comprises a polyaddition compound blended in an amount of 0.5 to 15 parts by weight, as solid content, per 100 parts by weight of total solid content of base resin and curing agent.

11. Cationic electrodeposition paint which comprises an aqueous dispersion added, at any stage of the preparation of cationic electrodeposition paint, in an amount as solid content of 0.1 to 20 parts by weight per 100 parts by weight of total solid content of base resin and curing agent, said aqueous dispersion having been prepared by adding organic acid, in an amount corresponding to 10 to 100 mgKOH per gram of solid content, to a polyaddition compound of claim 1 and thereby rendering the polyaddition compound water-dispersible.

12. Cationic electrodeposition paint of claim 11 wherein aqueous dispersion of polyaddition compound is blended in an amount as solid content of 0.5 to 15 parts by weight per 100 parts by weight of total solid content of base resin and curing agent.

13. Articles which have been electrocoated with cationic electrodeposition paint of claim 9.

14. Articles which have been electrocoated with cationic electrodeposition paint of claim 10.

15. Articles which have been electrocoated with cationic electrodeposition paint of claim 11.
